(19) United States
(12) Patent Application Publication
(10) Pub. No.: US 2024/0158182 A1
(43) Pub. Date: May 16, 2024

(54) TRANSPORT APPARATUS

(71) Applicant: DAIHEN Corporation, Osaka (JP)

(72) Inventors: Hiroto SAKAHARA, Osaka (JP); Takanobu IZUMI, Hyogo (JP)

(73) Assignee: DAIHEN Corporation, Osaka (JP)

(21) Appl. No.: 18/491,768

(22) Filed: Oct. 21, 2023

(30) Foreign Application Priority Data
Nov. 11, 2022 (JP) 2022-180726

(51) Int. Cl. B65G 47/90

(52) U.S. Cl. CPC B65G 47/90

(57) ABSTRACT

A transport apparatus that can position a transport target object, with a simple configuration. A transport apparatus includes first and second hand portions that simultaneously hold the transport target object; a moving portion moving the first and second hand portions in three axial directions; and a control for the moving portion. The first and second hand portions respectively include first and second holding portions that hold the transport target object, and first and second force sensors that respectively detect external forces applied to the first and second holding portions. The control portion controls the moving portion to move, toward a positioning point, the transport target object to which an upward force is applied within a range where the object does not float above a placement face, using the external forces detected by the first and second force sensors.

### CROSS REFERENCE TO RELATED APPLICATION

This application claims priority of Japanese Patent Application No. 2022-180726 filed Nov. 11, 2022. The entire contents of which are hereby incorporated by reference.

### FIELD OF THE INVENTION

The present invention relates to a transport apparatus that moves a transport target object toward a positioning point.

### BACKGROUND

Conventionally, there is a need to transport heavy transport target objects that are difficult for humans to transport, such as welding jigs and plasma power supplies, at manufacturing sites. It is conceivable to use a forklift in order to transport such a transport target object, but the weight of the transport target object may not be so large that the object has to be transported using a forklift. Also, if a transport target object is not placed on a pallet, it is difficult to transport the object using a forklift.

It is also conceivable to transport such a transport target object using a manipulator, but, if the hand portion of the manipulator cannot hold the transport target object near its center of gravity, a moment will be applied to the hand portion when the transport target object is transported. In order to cope with this moment, the strength of the manipulator has to be increased, resulting in a larger manipulator.

This moment issue can be solved by causing a dual-armed manipulator to simultaneously hold a transport target object at two points. For such dual-arm robots, innovations have been made to improve the operating range and workability (see JP 2020-189364A and JP 2022-108837A, for example).

However, a versatile dual-arm robot has a large number of axes, and thus the manipulator itself becomes heavy. Therefore, in order to increase the weight capacity, it is necessary to use a high-power motor for each axis, which leads to an issue that the size of the dual-arm robot becomes larger. On the other hand, if the size of the dual-arm robot is not increased, the weight capacity becomes smaller.

Furthermore, it is conceivable to reduce the number of axes in order to increase the weight capacity, but, if the number of axes is reduced, fine movement control for positioning becomes difficult.

### SUMMARY

The present invention was made in order to solve the above-described issues, and it is an object thereof to provide a transport apparatus that can position a transport target object, with a simple configuration.

In order to achieve the above-described object, an aspect of the present invention is directed to a transport apparatus including: first and second hand portions that are arranged at a distance from each other in a first direction in a horizontal plane and configured to simultaneously hold a transport target object, the first and second hand portions respectively including first and second holding portions that hold the transport target object, and first and second force sensors that respectively detect external forces applied to the first and second holding portions; a moving portion that moves the first and second hand portions independently of each other in the first direction, as well as in a second direction that is perpendicular to the first direction in the horizontal plane and in a vertical direction; and a control portion that controls the moving portion to move, toward a positioning point, the transport target object to which an upward force is applied within a range where the object does not float above a placement face, using the external forces detected by the first and second force sensors.

With the transport apparatus according to an aspect of the present invention, a transport target object can be moved in a sliding manner on a placement face, and the positioning can be performed by a positioning member placed on the placement face, for example. Accordingly, it is possible to position a transport target object, with a simple configuration.

### BRIEF DESCRIPTION OF THE DRAWINGS

FIG. 1 is a perspective view showing the configuration of a transport apparatus according to an embodiment of the present invention.

FIG. 2A is a front view showing an example of hand portions and a transport target object in the embodiment.

FIG. 2B is a front view showing an example of the hand portions and the transport target object in the embodiment.

FIG. 2C is a front view showing an example of the hand portions and the transport target object in the embodiment.

FIG. 3 is a functional block diagram showing the function of the transport apparatus in the embodiment.

FIG. 4 is a flowchart showing an operation of the transport apparatus in the embodiment.

FIG. 5 is a view illustrating an example of horizontal movement control in the embodiment.

FIG. 6A is a view showing an example of horizontal movement control in the embodiment.

FIG. 6B is a view showing an example of horizontal movement control in the embodiment.

FIG. 6C is a view showing an example of horizontal movement control in the embodiment.

FIG. 7 is a view showing an example of a positioning member in the embodiment.

FIG. 8 is a perspective view showing an example of the transport target object in the embodiment.

### DETAILED DESCRIPTION

Below, a transport apparatus according to the present invention will be described by way of the embodiment. The constituent elements and steps denoted by the same reference numerals in the following embodiment are similar or corresponding constituent elements and steps, and thus a description thereof may not be repeated. The transport apparatus according to this embodiment moves a transport target object to which an upward force is applied within a range where the object does not float above the placement face, toward a positioning point.

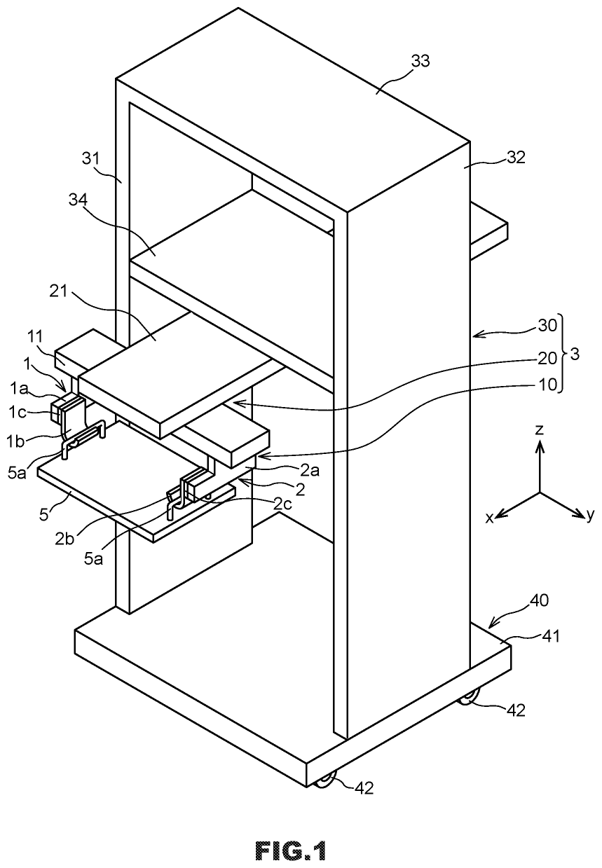

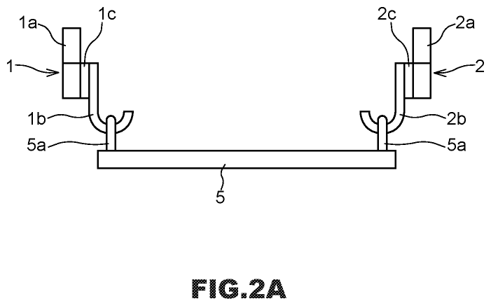

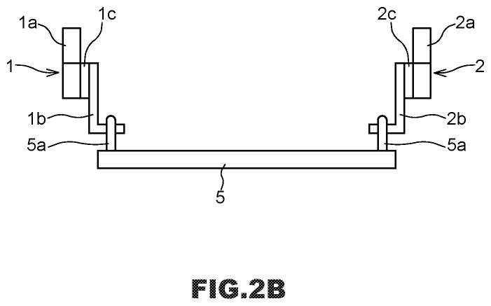

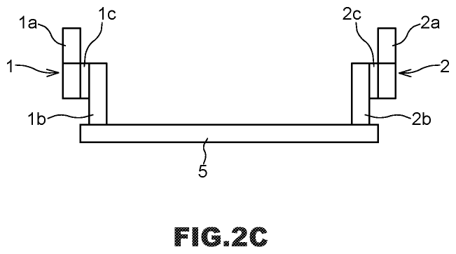

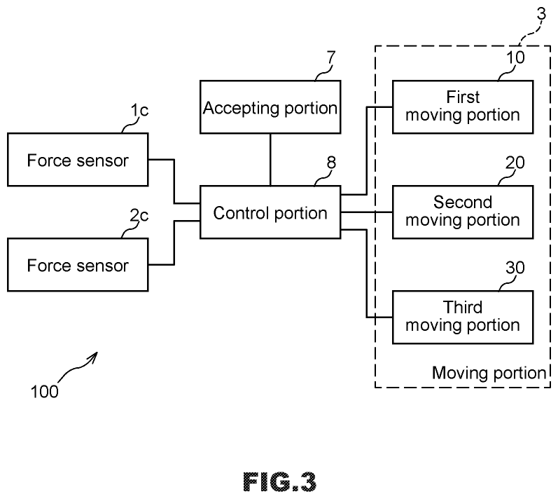

FIG. 1 is a perspective view showing a transport apparatus 100 according to this embodiment, FIG. 2A is a front view showing first and second hand portions 1 and 2 holding a transport target object 5, and FIG. 3 is a functional block diagram showing the function of the transport apparatus 100.

The transport apparatus 100 includes the first hand portion 1, the second hand portion 2, a moving portion 3, an accepting portion 7, a control portion 8, and a wheeled platform 40. The moving portion 3 may include a first moving portion 10, a second moving portion 20, and a third moving portion 30, for example.

The first hand portion 1 and the second hand portion 2 are arranged at a distance from each other in a first direction in a horizontal plane. The first hand portion 1 and the second hand portion 2 simultaneously hold the transport target object 5. The above-described moment issue can be solved by causing the first and second hand portions 1 and 2 to simultaneously hold the transport target object 5, and thus the moving portion 3 does not need to be enlarged. The first hand portion 1 may include a first base portion 1a, a first holding portion 1b that holds the transport target object 5, and a first force sensor 1c for detecting an external force that is applied to the first holding portion 1b, for example. The second hand portion 2 may include a second base portion 2a, a second holding portion 2b that holds the transport target object 5, and a second force sensor 2c for detecting an external force that is applied to the second holding portion 2b, for example. The first and second holding portions 1b and 2b may be connected directly or indirectly to the first and second base portions 1a and 2a, respectively.

The first and second force sensors 1c and 2c may be 3-axis or 6-axis force sensors, for example. It is assumed that the first and second force sensors 1c and 2c can acquire weights that are applied to the first and second holding portions 1b and 2b, respectively.

The first and second hand portions 1 and 2 are moved by the moving portion 3 in a first direction and a second direction that are in a horizontal plane and in a vertical direction. The second direction is a direction that is perpendicular to the first direction. That is to say, the first and second hand portions 1 and 2 are moved in each of the three axes in a cartesian coordinate system. In this embodiment, it is assumed that the first direction, the second direction, and the vertical direction are respectively the y-axis direction, the x-axis direction, and the z-axis direction shown in FIG. 1.

The method in which the first and second hand portions 1 and 2 hold the transport target object 5 is not limited. As shown in FIGS. 1 and 2A, the first and second hand portions 1 and 2 may hold the transport target object 5 in a suspending manner. In this embodiment, a case will be mainly described in which the first and second holding portions 1b and 2b that hold the transport target object 5 in a suspending manner each have a cross-section in the shape of the letter “J”, but the first and second holding portions 1b and 2b may have cross-sections in other shapes as will be described later. The first and second hand portions 1 and 2 may hold the transport target object 5 by means of electromagnets, may hold the transport target object 5 by means of a vacuum adsorption mechanism, or may hold the transport target object 5 using other methods, as will be described later.

The transport target object 5 is not particularly limited, but may be an object used at manufacturing sites, such as a plasma power supply or a welding jig, for example. The weight of the transport target object 5 is not particularly limited, but may be a weight that makes it difficult for humans to transport the object, such as 30 kg or more or 50 kg or more, for example. The weight of the transport target object 5 may be a weight that does not require to use a large transport vehicle such as a forklift, such as 200 kg or less, 150 kg or less, or 100 kg or less, for example.

FIG. 1, etc. show a case in which the transport target object 5 is a plate-like member, for example, but the transport target object 5 may be a three-dimensional object or a plate-like member on which another device or the like is placed. In the latter case, for example, the plate-like member and the device or the like placed on the plate-like member may be the transport target object 5. When the transport target object 5 is suspended by the first and second hand portions 1 and 2, the transport target object 5 may be provided with two holdable portions 5a such as handles, as shown in FIG. 1, etc. The transport target object 5 may be held by the first and second hand portions 1 and 2 by causing the first and second holding portions 1b and 2b to suspend the object at the holdable portions 5a.

Furthermore, for example, there may be play between the first and second hand portions 1 and 2 and the transport target object 5 in a state in which the first and second hand portions 1 and 2 hold the transport target object 5. That is to say, the relative positional relationship between the first and second hand portions 1 and 2 and the transport target object 5 may not be fixed and may be changeable in a state in which the first and second hand portions 1 and 2 hold the transport target object 5.

Furthermore, for example, faces of the first and second hand portions 1 and 2 that come into contact with the transport target object 5 when the first and second hand portions 1 and 2 hold the transport target object 5 may be faces with a low coefficient of friction. The faces with a low coefficient of friction may be faces constituted by or coated with a material with a low coefficient of friction such as fluororesin or monomer-cast nylon. The fluororesin is not particularly limited, but may be polytetrafluoroethylene, PEP (perfluoroethylene-propene copolymer), PFA (perfluoroalkoxyalkane), or the like, for example. The monomer-cast nylon is particularly preferably of sliding grade, and may be sliding grade MC nylon (registered trademark), for example.

Since there is play between the first and second hand portions 1 and 2 and the transport target object 5 in a state in which the first and second hand portions 1 and 2 hold the transport target object 5, or since faces of the first and second hand portions 1 and 2 that come into contact with the transport target object 5 at that time are faces with a low coefficient of friction in this manner, the transport target object 5 can move more easily over the first and second hand portions 1 and 2 during positioning of the transport target object 5, resulting in appropriate positioning even if the first and second hand portions 1 and 2 are not able to perform fine movements for positioning.

The moving portion 3 moves the first and second hand portions 1 and 2 independently of each other in the first direction, as well as in a second direction that is perpendicular to the first direction in the horizontal plane and in a vertical direction. In this embodiment, a case will be mainly described in which the moving portion 3 has the first to third moving portions 10, 20, and 30. Also, in this embodiment, a case will be mainly described in which the moving portion 3 moves the first and second hand portions 1 and 2 together in the second direction and the vertical direction, but there is no limitation to this. The moving portion 3 may move the first and second hand portions 1 and 2 independently of each other in at least one of the second direction and the vertical direction as well.

The first moving portion 10 supports the first and second hand portions 1 and 2 and moves each of the first and second hand portions 1 and 2 in the first direction. The first moving portion 10 can preferably move the first and second hand portions 1 and 2 independently of each other in the first direction, for example. The transport target object 5 can be held or released by the first and second hand portions 1 and 2 by causing the first moving portion 10 to move the first and second hand portions 1 and 2, for example. The transport target object 5 held by the first and second hand portions 1 and 2 can also be moved in the first direction by causing the first moving portion 10 to simultaneously move the first and second hand portions 1 and 2 in the same direction, for example.

The first moving portion 10 may include a first support portion 11 that supports the first and second hand portions 1 and 2, and first and second linear actuators that move the first and second hand portions 1 and 2 independently of each other in the first direction with respect to the first support portion 11, for example. More specifically, a guide along the first direction may be provided on the bottom face of the first support portion 11 extending in the first direction, and sliders may be assembled to the guide so as to be slidable in the first direction. The first and second base portions 1a and 2a of the first and second hand portions 1 and 2 may be respectively fixed to different sliders.

The second moving portion 20 supports the first moving portion 10 and moves the first moving portion 10 in the second direction. Thus, the second moving portion 20 moves the first and second hand portions 1 and 2 together in the second direction. The second moving portion 20 may include a second support portion 21 that supports the first support portion 11 of the first moving portion 10, and a linear actuator that moves the first support portion 11 in the second direction with respect to the second support portion 21, for example More specifically, a guide along the second direction may be provided on the bottom face of the second support portion 21 extending in the second direction, and a slider may be assembled to the guide so as to be slidable in the second direction. The upper face of the first support portion 11 may be fixed to the slider.

The third moving portion 30 supports the second moving portion 20 and moves the second moving portion 20 in the vertical direction. Thus, the third moving portion 30 moves the first and second hand portions 1 and 2 together in the vertical direction. The third moving portion 30 may include a pair of support posts 31 and 32 that are arranged at a distance from each other in the first direction, a top plate 33 that connects the upper ends of the support posts 31 and 32, a vertically moving portion 34 that is supported at its ends by the pair of support posts 31 and 32 and supports the second support portion 21 of the second moving portion 20, and a pair of linear actuators that synchronously move the vertically moving portion 34 in the vertical direction with respect to the pair of support posts 31 and 32, for example More specifically, guides along the vertical direction may be respectively provided on faces on the vertically moving portion 34 side of the support posts 31 and 32 extending in the vertical direction, and sliders may be assembled to the guides as to be slidable in the vertical direction. The two ends in the first direction of the vertically moving portion 34 may be respectively fixed to the sliders.

In the first to third moving portions 10, 20, and 30, for example, a slider may be assembled to two or more parallel guides. The linear actuators included in the first to third moving portions 10, 20, and 30 may independently have a rack and pinion mechanism and a drive unit for rotating the pinion, a ball screw mechanism and a drive unit for rotating the screw shaft of the ball screw mechanism, a pair of pulleys, an endless belt passed over the pair of pulleys, and a drive unit for rotating the pulleys, a mechanism using sprockets and an endless chain instead of the pulleys and belt, or other configurations, for example. The mechanisms for moving a supported object in a linear direction using a guide, a slider, a linear actuator, etc. are already well known, and thus its detailed description is omitted. In FIG. 1, guides, sliders, and linear actuators are not shown.

The accepting portion 7 may accept operations and instructions from the user. The accepting portion 7 may accept operations and instructions related to the moving portion 3, or may accept operations and instructions related to the wheeled platform 40, for example. The acceptance may be acceptance of information input from an input device (e.g., a keyboard, a mouse, a touch panel, etc.) or reception of information transmitted via a wired or wireless communication line, for example. The accepting portion 7 may or may not include an accepting device (e.g., an input device, a communication device, etc.). The accepting portion 7 may be realized by hardware, or software such as a driver that drives a given device.

The control portion 8 controls the moving portion 3. This control by the control portion 8 causes the transport target object 5 to be held or released by the first and second hand portions 1 and 2, for example. This control also causes the transport target object 5 to be loaded or unloaded, for example. This control also causes the transport target object 5 to be locally transported (e.g., positioned), for example. These controls may be performed in response to an operation accepted by the accepting portion 7, or autonomously by the control portion 8, for example. For example, if the wheeled platform 40 has a drive unit, the control portion 8 may also control the movement of the wheeled platform 40. The movement control of the wheeled platform 40 may be movement control concerning the movement direction and movement speed in response to an operation accepted by the accepting portion 7, or control of autonomous movement from a predetermined start point to a destination, for example. The specific control by the control portion 8 will be described later.

The base ends of the moving portion 3 are fixed to the wheeled platform 40. The base ends of the moving portion 3 may be the base ends, that is, the lower ends of the third moving portion 30, for example. The wheeled platform 40 may include a base 41 to which the base ends of the third moving portion 30 are fixed, and multiple traveling units 42 that are fixed to the base 41 and can travel on a traveling face such as a floor surface, for example. The base 41 may be a plate-like member, for example. The traveling units 42 are typically wheels, but may be those other than wheels, such as rollers, endless tracks, or ball casters with balls. The wheeled platform 40 may or may not have a drive unit for driving the traveling units 42. In the latter case, the wheeled platform 40 may be moved manually. The manually moved wheeled platform 40 may include a securing unit for securing the traveling units 42 in order to prevent the wheeled platform 40 from moving during the local transport of the transport target object 5 by the moving portion 3. The securing unit may be wheel stoppers, for example. In this embodiment, a case will be mainly described in which the wheeled platform 40 does not have a drive unit and is moved manually. The transport target object 5 is transported locally by the moving portion 3, whereas the transport target object 5 is transported in a larger area by the wheeled platform 40.

Hereinafter, the control of the moving portion 3 by the control portion 8 will be described. As described above, the control of the moving portion 3 by the control portion 8 may be performed autonomously or in response to an operation accepted by the accepting portion 7, but it is assumed that the control portion 8 at least autonomously controls the positioning of the transport target object 5 held by the first and second hand portions 1 and 2. In the control of positioning, the control portion 8 may control the moving portion 3 to move, toward a positioning point, the transport target object 5 to which an upward force is applied within a range where the object does not float above the placement face, using the external forces detected by the first and second force sensors 1c and 2c.

Since the transport target object 5 is held in a state in which an upward force is applied thereto within a range where the object does not float above the placement face, the control portion 8 may perform control as follows. First, the control portion 8 controls the moving portion 3 such that the transport target object 5 held by the first and second hand portions 1 and 2 floats above the placement face. Subsequently, in a state in which the weight of the transport target object 5 is supported only by the first and second hand portions 1 and 2, the control portion 8 acquires the weight of the transport target object 5 using the external forces detected by the first and second force sensors 1c and 2c, and records the weight in a recording medium (not shown). This weight may be the sum of the weights respectively detected by the first and second force sensors 1c and 2c, or a representative value of the weights respectively detected by the first and second force sensors 1c and 2c, for example. The representative value may be an average value, a maximum value, a minimum value, or the like, for example.

Subsequently, the control portion 8 controls the moving portion 3 to lower the transport target object 5 such that the transport target object 5 is held in a state in which an upward force is applied thereto within a range where the object does not float above the placement face. More specifically, the control portion 8 controls the moving portion 3 such that the weight acquired using the external forces detected by the first and second force sensors 1c and 2c is smaller than the recorded weight. This weight acquired using the external forces detected by the first and second force sensors 1c and 2c is preferably of the same type as the recorded weight. For example, both may be the sum of the weights respectively detected by the first and second force sensors 1c and 2c or the average value of the weights respectively detected by the first and second force sensors 1c and 2c. When causing the transport target object 5 to be held in a state in which an upward force is applied thereto within a range where the object does not float above the placement face, the control portion 8 may perform control such that the weight acquired using the external forces detected by the first and second force sensors 1c and 2c is a value obtained by multiplying the recorded weight by a positive real number smaller than 1, such as ½ or ⅓, for example, a value in the range of 10% to 90% of the recorded weight. When the transport target object 5 is held in a state in which an upward force is applied thereto within a range where the object does not float above the placement face in this manner, the weight of the transport target object 5 is distributed and supported by both the first and second hand portions 1 and 2 and the placement face on which the transport target object 5 is placed. Accordingly, the friction between the bottom face of the transport target object 5 and the placement face is reduced, and the transport target object 5 can be moved in a sliding manner on the placement face with less force. Even in the case in which the weight of the transport target object 5 is large, the transport target object 5 can be moved more easily on the placement face.

When holding the transport target object 5 in a state in which an upward force is applied thereto within a range where the object does not float above the placement face, it is typically sufficient to cause the moving portion 3 to keep the vertical height of the transport target object 5 constant. However, for example, if the vertical height of the transport target object 5 is kept constant when the transport target object 5 is being positioned on an inclined face, the transport target object 5 may float above the placement face in accordance with movement of the transport target object 5 along the inclined face, or an upward force may not be applied to the transport target object 5. Accordingly, if the vertical height of the transport target object 5 may change during horizontal movement of the transport target object 5 for positioning, the control portion 8 may perform control such that the upward force that is applied to the transport target object 5 is constant within a range where the object does not float above the placement face. That is to say, the control portion 8 may change the vertical height of the transport target object 5 by controlling the moving portion 3 such that the weight acquired using the external forces detected by the first and second force sensors 1c and 2c is constant, during movement of the transport target object 5 for positioning.

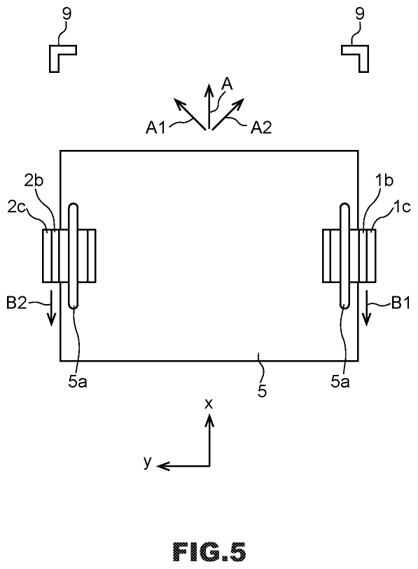

Furthermore, in order to move the transport target object 5 to which an upward force is applied within a range where the object does not float above the placement face, toward a positioning point, the control portion 8 may perform control as follows. For example, positioning members 9 for positioning the transport target object 5 may be arranged at the positioning point, as shown in FIG. 5. The number of positioning members 9 may be two as shown in FIG. 5, or one or three or more, for example. The positioning members 9 may position the transport target object 5 by engaging with specific points of the transport target object 5 (adjacent corners in the rectangular transport target object 5 in plan view in FIG. 5), for example. The positioning members 9 may be fixed to the placement face on which the transport target object 5 is to be placed, for example The positioning members 9 are preferably high enough to be able to position the transport target object 5. The height is not particularly limited, but may be 2 cm or more, 5 cm or more, or 10 cm or more, for example.

In the case shown in FIG. 5, for example, the control portion 8 first moves the transport target object 5 to which an upward force is applied within a range where the object does not float above the placement face, in the direction of the arrow A from the positioning control start point. The direction of the arrow A is the positive direction of the x-axis. The control portion 8 refers to the external forces in the horizontal direction respectively acquired by the first and second force sensors 1c and 2c during the movement. If a force in the direction of the arrow B1, that is, a force in the negative direction of the x-axis is detected only by the first force sensor 1c, the transport target object 5 is considered to have contacted only the right positioning member 9 in FIG. 5, and the transport target object 5 has to be moved in the left direction. Thus, the control portion 8 may control the moving portion 3 to move the transport target object 5 in the direction of the arrow A1. On the other hand, if a force in the direction of the arrow B2, that is, a force in the negative direction of the x-axis is detected only by the second force sensor 2c, the transport target object 5 is considered to have contacted only the left positioning member 9 in FIG. 5, and the transport target object 5 has to be moved in the right direction. Thus, the control portion 8 may control the moving portion 3 to move the transport target object 5 in the direction of the arrow A2.

The case in which a force in the direction of the arrow B1 is detected only by the first force sensor 1c may be a case in which the absolute values of the forces in the y-axis direction detected by the first and second force sensors 1c and 2c are both smaller than a first threshold value, and a result obtained by subtracting the force in the negative direction of the x-axis detected by the second force sensor 2c from the force in the negative direction of the x-axis detected by the first force sensor 1c is larger than a second threshold value, which is a positive real number, for example. Also, the case in which a force in the direction of the arrow B2 is detected only by the second force sensor 2c may be a case in which the absolute values of the forces in the y-axis direction detected by the first and second force sensors 1c and 2c are both smaller than the first threshold value, and a result obtained by subtracting the force in the negative direction of the x-axis detected by the first force sensor 1c from the force in the negative direction of the x-axis detected by the second force sensor 2c is larger than the second threshold value, which is a positive real number, for example.

Furthermore, if a force in the direction of the arrow B1 is no longer detected by the first force sensor 1c during control of the moving portion 3 to move the transport target object 5 in the direction of the arrow A1, the control portion 8 may control the moving portion 3 to move the transport target object 5 in the direction of the arrow A again. In a similar manner, if a force in the direction of the arrow B2 is no longer detected by the second force sensor 2c during control of the moving portion 3 to move the transport target object 5 in the direction of the arrow A2, the control portion 8 may control the moving portion 3 to move the transport target object 5 in the direction of the arrow A again.

Furthermore, if forces in the directions of the arrows B1 and B2 are respectively detected by both the first and second force sensors 1c and 2c during control of the moving portion 3 to move the transport target object 5 in the direction of the arrow A, the transport target object 5 is considered to have reached the positioning point, and thus the control portion 8 may end the movement of the transport target object 5. The case in which forces in the directions of the arrows B1 and B2 are respectively detected by both the first and second force sensors 1c and 2c may be a case in which the absolute value of the difference between the forces in the x-axis direction detected by the first and second force sensors 1c and 2c is smaller than the second threshold value, and the absolute value of the sum of the forces in the x-axis direction detected by the first and second force sensors 1c and 2c is larger than a third threshold value, for example.

The control portion 8 may perform controls other than those described above to move the transport target object 5 to which an upward force is applied within a range where the object does not float above the placement face, toward a positioning point. For example, when moving the transport target object 5 horizontally from the positioning start point toward the positioning point, the control portion 8 may composite the vector in the movement direction (e.g., the vector in the direction of the arrow A in FIG. 5) and the vector of the external force in the horizontal direction detected by the first and second force sensors 1c and 2c, and move the transport target object 5 in the direction of the vector of the composite result. The vector of the external force in the horizontal direction detected by the first and second force sensors 1c and 2c may be a result obtained by compositing two vectors respectively corresponding to the external forces in the horizontal direction detected by the first and second force sensors 1c and 2c, for example. In this case, for example, when the vector of the external force in the horizontal direction detected by the first and second force sensors 1c and 2c becomes opposite to the vector in the movement direction from the positioning start point toward the positioning point and the size of the vector becomes greater than a predetermined threshold value, the horizontal movement may be ended.

The control portion 8 may use, as the external force detected by the first and second force sensors 1c and 2c, a value obtained by processing the external force detected by the first and second force sensors 1c and 2c with a moving average filter. The above-mentioned threshold values are preferably set as appropriate to enable the desired positioning.

Furthermore, when moving the transport target object 5 in the direction of the arrow A, the control portion 8 may move the first moving portion 10 in the direction of the arrow A by operating the drive unit of the linear actuator included in the second moving portion 20, for example. When moving the transport target object 5 in the direction of the arrow A1 or the arrow A2, the control portion 8 may synchronously move both the first and second hand portions 1 and 2 in the first direction by synchronously operating the drive units of the first and second linear actuators included in the first moving portion 10, and move the first moving portion 10 in the second direction by operating the drive unit of the linear actuator included in the second moving portion 20, for example. When lifting or lowering the transport target object 5 held by the first and second hand portions 1 and 2, the control portion 8 may lift or lower the vertically moving portion 34 in the vertical direction by synchronously operating the drive units of the pair of linear actuators included in the third moving portion 30, for example.

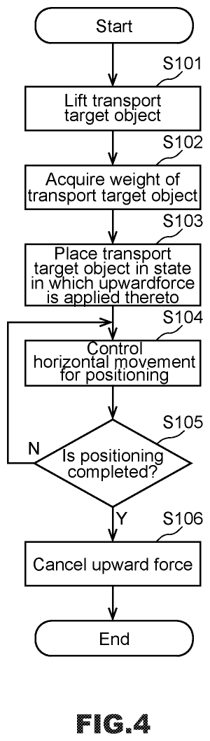

Next, the operation in which the transport apparatus 100 positions the transport target object 5 will be described with reference to the flowchart in FIG. 4.

(Step S101) The control portion 8 controls the moving portion 3 to lift the first and second hand portions 1 and 2 to a state in which the transport target object 5 held by the first and second hand portions 1 and 2 floats above the placement face.

(Step S102) The control portion 8 acquires the weight of the transport target object 5 detected by the first and second force sensors 1c and 2c, and records the weight.

(Step S103) The control portion 8 controls the moving portion 3 to lower the first and second hand portions 1 and 2 to a state in which an upward force is applied to the transport target object 5 held by the first and second hand portions 1 and 2 within a range where the object does not float above the placement face. The transport target object 5 is preferably at the positioning control start point when the first and second hand portions 1 and 2 are lowered.

(Step S104) The control portion 8 controls the moving portion 3 using the external forces in the horizontal direction detected by the first and second force sensors 1c and 2c to horizontally move the transport target object 5 to which an upward force is applied within a range where the object does not float above the placement face. The transport target object 5 is horizontally moved from the positioning control start point to the positioning point by repeating the processing in step S104.

(Step S105) The control portion 8 determines whether or not the positioning control is completed. If the positioning control is completed, the procedure advances to step S106, or otherwise the procedure returns to step S104.

(Step S106) The control portion 8 cancels the upward force applied to the transport target object 5. As a result, the weight of the transport target object 5 is supported only by the placement face. The series of processes for positioning the transport target object 5 are thus completed.

If the transport target object 5 is held by the first and second hand portions 1 and 2 in a floating state above the placement face at the start of the positioning operation, the processing in step S101 may not be performed. Although not included in the flowchart in FIG. 4, processing other than positioning, such as causing the first and second hand portions 1 and 2 to hold or release the transport target object 5, may also be performed by the control portion 8. That processing may be performed in response to an operation accepted by the accepting portion 7, for example.

Next, an operation of the transport apparatus 100 according to this embodiment will be described by way of a specific example. In this specific example, a case will be described in which the transport target object 5 is transported from a first position to a second position and positioning is performed at the second position. It is assumed that the two positioning members 9 shown in FIG. 5 are placed on the placement face at the second position.

First, the user manually moves the transport apparatus 100 to the vicinity of the transport target object 5 that is present at the first position. Then, after moving the transport apparatus 100 to the vicinity of the transport target object 5, the user secures the traveling units 42 of the wheeled platform 40 to prevent them from moving.

Subsequently, the user inputs an operation to pick up the transport target object 5 that is placed at the first position and move the transport target object 5 to a position near the center of the wheeled platform 40 in plan view. This operation is accepted by the accepting portion 7 and passed to the control portion 8. The control portion 8 controls the moving portion 3 according to the operation to lift the transport target object 5 held by the first and second hand portions 1 and 2 and move the transport target object 5 to a position near the center of the wheeled platform 40 in plan view.

Next, the user cancels the securing of the traveling units 42 and manually moves the transport apparatus 100 to the vicinity of the second position. Subsequently, the user secures the traveling units 42 of the wheeled platform 40 to prevent them from moving. Then, the user inputs an operation to lower the transport target object 5 to the positioning start point at the second position. This operation is accepted by the accepting portion 7 and passed to the control portion 8. The control portion 8 controls the moving portion 3 according to the operation to place the transport target object 5 at the positioning start point.

Subsequently, when the user inputs an instruction to perform positioning, the instruction is accepted by the accepting portion 7 and passed to the control portion 8. Then, the control portion 8 starts the positioning control. Specifically, the control portion 8 first controls the third moving portion 30 to lift the first and second hand portions 1 and 2 to a state in which the transport target object 5 floats above the placement face (Step S101). At that time, the control portion 8 acquires the weight of the transport target object 5 using the external forces detected by the first and second force sensors 1c and 2c, and records the weight (Step S102). It is assumed that this weight is the sum of the weights respectively detected by the first and second force sensors 1c and 2c.

Next, the control portion 8 controls the third moving portion 30 to lower the first and second hand portions 1 and 2 to a state in which an upward force is applied to the transport target object 5 within a range where the object does not float above the placement face (Step S103). Specifically, the control portion 8 may cause the third moving portion 30 to lower the first and second hand portions 1 and 2 until the sum of the weights detected by the first and second force sensors 1c and 2c becomes ½ or ⅓ of the recorded weight.

Next, the control portion 8 controls the moving portion 3 to move the transport target object 5 in the direction of the arrow A in FIG. 5 in a state in which an upward force is applied thereto within a range where the object does not float above the placement face (Step S104). The transport target object 5 is caused to move closer to the two positioning members 9 in a sliding manner on the placement face by continuing this processing (Steps S104 and S105).

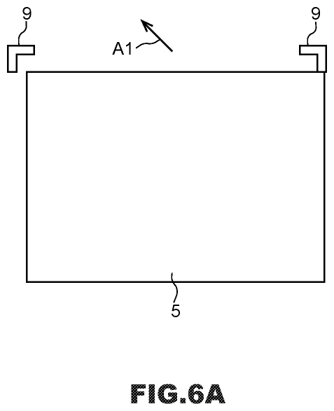

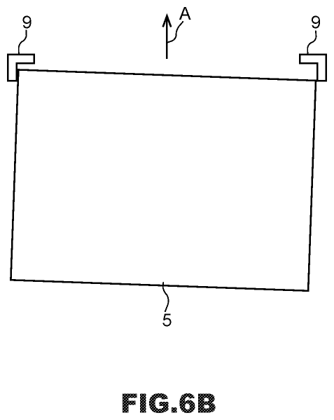

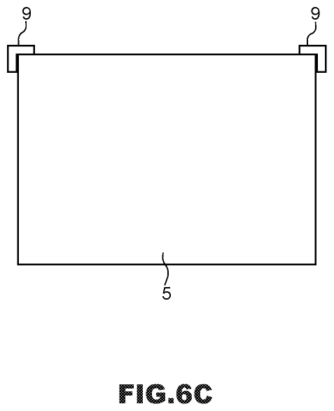

Subsequently, it is assumed that the upper right corner of the transport target object 5 comes into contact with the positioning member 9 as shown in FIG. 6A. Although the holdable portions 5a and the first and second hand portions 1 and 2 are not shown in FIG. 6A, it is assumed that the right and left sides of the transport target object 5 are respectively held by the first and second hand portions 1 and 2 as in FIG. 5. The same applies to FIGS. 6B and 6C.

When the upper right corner of the transport target object 5 comes into contact with the positioning member 9, a force in the direction of the arrow B1 is detected only by the first force sensor 1c. Accordingly, the control portion 8 controls the moving portion 3 to move the transport target object 5 in the direction of the arrow A1 (Step S104). It is assumed that, as this processing continues, the upper right corner of the transport target object 5 is no longer in contact with the positioning member 9 as shown in FIG. 6B. Then, since the force in the direction of the arrow B1 is no longer detected by the first force sensor 1c, the control portion 8 controls the moving portion 3 to move the transport target object 5 in the direction of the arrow A (Step S104).

Subsequently, when the transport target object 5 reaches the positioning point as shown in FIG. 6C, forces in the directions of the arrows B1 and B2 are respectively detected by both the first and second force sensors 1c and 2c. Then, the control portion 8 determines that the positioning of the transport target object 5 is completed, and cancels the upward force applied to the transport target object 5 (Steps S105 and S106). In this manner, the series of processes for positioning the transport target object 5 are ended. Subsequently, the control portion 8 may perform control to cause the first and second holding portions 1b and 2b to release the holdable portions 5a. Specifically, the control portion 8 may control the third moving portion 30 to lower the first and second hand portions 1 and 2 and control the first moving portion 10 to move both the first and second hand portions 1 and 2 in the first direction away from the holdable portions 5a.

In this specific example, a case was described in which control other than that for positioning is performed in response to operations accepted from the user was described, but there is no limitation to this. The transport apparatus 100 may autonomously load and unload the transport target object 5, for example, and furthermore, the movement by the wheeled platform 40 may also be performed autonomously.

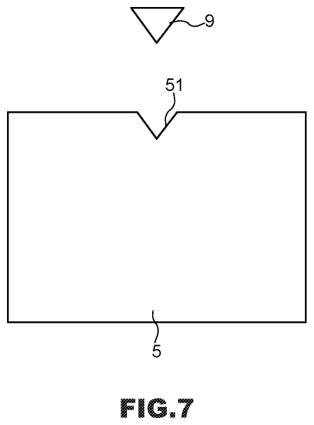

Furthermore, the positioning members 9 used in FIGS. 5 and 6A, etc. are merely an example, and other positioning members may be used. For example, it is also possible that, as shown in the plan view in FIG. 7, a triangular positioning member 9 is disposed on the placement face, and positioning is performed by moving the transport target object 5 such that a notch 51 in the transport target object 5 engages with the positioning member 9. As long as positioning can be eventually performed in this manner, various positioning members may be used. A notch or the like that engages with the positioning member 9 may be provided in the transport target object 5 as shown in FIG. 7, or a corner or the like of the transport target object 5 may engage with the positioning member 9 as shown in FIG. 5.

As described above, with the transport apparatus 100 according to this embodiment, the transport target object 5 can be moved in a sliding manner on the placement face by moving, toward a positioning point, the transport target object 5 to which an upward force is applied within a range where the object does not float above the placement face, using the external forces detected by the first and second force sensors 1c and 2c, and the positioning can be performed using the positioning members 9 arranged on the placement face. For example, the transport target object 5 such as a welding jig has to be positioned with high precision. The transport apparatus 100 according to this embodiment makes it possible to achieve precise positioning. Also, even in the case in which movement control cannot be performed with high precision by the moving portion 3, for example, the case in which the number of axes the moving portion 3 is small, the positioning using the positioning members 9 makes it possible to achieve precise positioning. Thus, the configuration of the moving portion 3 can be simplified. When the moving portion 3 is installed on the wheeled platform 40, the movement control by the wheeled platform 40 is typically not so precise, and thus, even if the moving portion 3 can achieve precise movement, it may not be possible to achieve precise movement control as a result of the presence of an error in the position of the wheeled platform 40 at the destination. On the other hand, when positioning is performed using the positioning members 9 as in the transport apparatus 100 according to this embodiment, desired positioning can be achieved even if there is an error in the position of the wheeled platform 40 at the destination.

Furthermore, since there is play between the first and second hand portions 1 and 2 and the transport target object 5 in a state in which the first and second hand portions 1 and 2 hold the transport target object 5, even when movement of the transport target object 5 by the moving portion 3 is not precise, the transport target object 5 can be aligned with the positioning members 9 within the range of the play, resulting in appropriate positioning. Since faces of the first and second hand portions 1 and 2 that come into contact with the transport target object 5 when the first and second hand portions 1 and 2 hold the transport target object 5 are faces with a low coefficient of friction, the position of the transport target object 5 can be easily changed within the range of play, resulting in more appropriate positioning of the transport target object 5.

When the moving portion 3 is on the wheeled platform 40, the moving portion 3 can not only locally position the transport target object 5 but also move the transport target object 5 in a larger area.

In this embodiment, a case was mainly described in which the upward force that is applied to the transport target object 5 when the moving portion 3 moves the transport target object 5 in a sliding manner on the placement face is constant, but there is no limitation to this. The control portion 8 may change the upward force that is applied to the transport target object 5 within a range where the object does not float above the placement face, when moving the transport target object 5 toward a positioning point. In this case, for example, the control portion 8 may repeatedly increase and decrease the upward force within a range where the transport target object 5 does not float above the placement face. More specifically, the control portion 8 may control the moving portion 3, for example, the third moving portion 30 such that the weight acquired using the external forces detected by the first and second force sensors 1c and 2c repeatedly increases and decreases within a range of 20% to 80% of the recorded weight. Accordingly, the transport target object 5 can be moved in a sliding manner, regardless of the amount of friction on the placement face. For example, the control portion 8 may increase the upward force within a range where the transport target object 5 does not float above the placement face, in order to enable the transport target object 5 to be moved with less force when the force required to move the transport target object 5 horizontally on the placement face is large. That is to say, the control portion 8 may adaptively increase the upward force within a range where the transport target object 5 does not float above the placement face, in order to enable the transport target object 5 to be horizontally moved on the placement face with a predetermined force, for example. That predetermined force is typically a small force.

Furthermore, the control portion 8 may perform controls other than those described above to move the transport target object 5 to which an upward force is applied within a range where the object does not float above the placement face, toward a positioning point. The control portion 8 may randomly change the position of the transport target object 5 in a direction orthogonal to the direction of travel when moving the transport target object 5 from the positioning start point toward the positioning point, for example. The degree of the change may be the degree of misalignment that may occur between the transport target object 5 and the positioning member when moving the transport target object 5 from the positioning start point toward the positioning point. This random change in position in the control can guide the transport target object 5 to a position where it engages with the positioning member, and the positioning using the positioning member can be eventually achieved. The processing for completing the positioning may be as described above.

Furthermore, as described above, the first and second holding portions 1b and 2b that hold the transport target object 5 in a suspending manner may have cross-sections in the shape other than the letter “J”. The first and second hand portions 1 and 2 may hold the transport target object 5 in a suspending manner, using the first and second holding portions 1b and 2b each having a cross-section in the shape of the letter “L” as shown in FIG. 2B, for example.

Furthermore, the first and second hand portions 1 and 2 may hold the transport target object 5 by means of electromagnets. In this case, for example, as shown in FIG. 2C, the upper face of the transport target object 5 may be held by the first and second holding portions 1b and 2b constituted by electromagnets. It is preferable that the transport target object 5 held by the first and second holding portions 1b and 2b constituted by electromagnets is typically made of a ferromagnetic material such as iron. If the transport target object 5 is made of a material other than a ferromagnetic material, a holdable portion made of a ferromagnetic material may be provided on the transport target object 5, for example. The face of the transport target object 5 that comes into contact with the first and second holding portions 1b and 2b constituted by electromagnets is preferably flat. If the first and second holding portions 1b and 2b are constituted by electromagnets, the electromagnets may be energized when holding the transport target object 5 and de-energized when canceling the holding. If the first and second hand portions 1 and 2 hold the transport target object 5 by means of electromagnets, the transport target object 5 can be prevented from being displaced when the holding is canceled, enabling precise positioning. If the transport target object 5 is made of a ferromagnetic material, a holdable portion does not have to be provided on the transport target object 5.

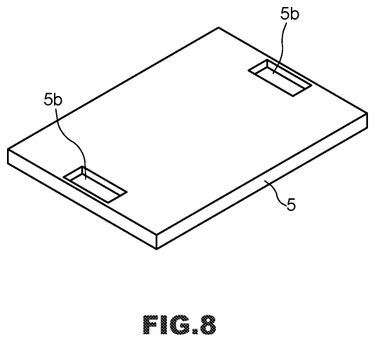

Even in the case in which there is play between the first and second hand portions 1 and 2 and the transport target object 5 in a state in which the first and second hand portions 1 and 2 hold the transport target object 5, the transport target object 5 is preferably prevented from falling from the first and second hand portions 1 and 2. Accordingly, for example, if the first and second holding portions 1b and 2b constituted by electromagnets hold the transport target object 5 as shown in FIG. 2C, the first and second holding portions 1b and 2b constituted by electromagnets may hold the transport target object 5, at the positions of recesses 5b in the upper face of the transport target object 5 as shown in FIG. 8. The recesses 5b are regions recessed downward from the upper face of the transport target object 5. The bottom faces of the recesses 5b are preferably flat. The regions of the recesses 5b in plan view are set to be larger than the faces of the first and second holding portions 1b and 2b that come into contact with the transport target object 5. Accordingly, even when the positions at which the transport target object 5 is held by the first and second holding portions 1b and 2b constituted by electromagnets change, the contact faces of the first and second holding portions 1b and 2b will be within the regions of the recesses 5b, and the first and second holding portions 1b and 2b can be prevented from being detached from the transport target object 5.

Furthermore, in this embodiment, when controlling the moving portion 3 to move the first and second hand portions 1 and 2 upward, if the weights acquired by the first and second force sensors 1c and 2c of the first and second hand portions 1 and 2 match each other, the control portion 8 may move the first and second hand portions 1 and 2 upward, or otherwise the control portion 8 may not move the first and second hand portions 1 and 2 upward. Accordingly, for example, a situation can be avoided in which the first and second hand portions 1 and 2 are moved upward in a state in which the transport target object 5 is held by only one of the first and second hand portions 1 and 2. The state in which the weights acquired by the first and second force sensors 1c and 2c match each other may be a state in which they exactly match each other or a state in which they match each other within the margin of error. The error may be a measurement error or an error according to the bias of the center of gravity of the transport target object 5, for example.

Furthermore, in this embodiment, a case was mainly described in which the moving portion 3 has the first to third moving portions 10, 20, and 30, but, as long as the first and second hand portions 1 and 2 can be eventually moved independently of each other in the first direction and the first and second hand portions 1 and 2 can be eventually moved independently or all together in the second direction and the vertical direction, the moving portion 3 may have other configurations. The moving portion 3 may include a first moving portion for moving the first hand portion 1 in the vertical direction, a second moving portion for moving the second hand portion 2 in the vertical direction, a third moving portion for moving the first moving portion in the first direction, a fourth moving portion for moving the second moving portion in the first direction, and a fifth moving portion for moving the third and fourth moving portions in the second direction, for example. The moving portion 3 may include a first moving portion for moving the first hand portion 1 in the first and second directions and in the vertical direction and a second moving portion for moving the second hand portion 2 in the first and second directions and in the vertical direction, for example. In this case, the base ends of the first and second moving portions may be fixed to one wheeled platform 40 or to separate wheeled platforms.

Furthermore, in this embodiment, at least part of the first and second holding portions 1b and 2b may be constituted by an elastic member, for example. In this case, the first and second holding portions 1b and 2b themselves are elastically deformed to allow the position of the transport target object 5 held by the first and second holding portions 1b and 2b to change within the range of the elastic deformation, and thus a state similar to that in which there is play between the first and second hand portions 1 and 2 and the transport target object 5 can be provided. Since the first and second holding portions 1b and 2b have to be capable of holding the transport target object 5 of a certain weight, the elastic members is preferably of strength. For example, plate springs or coil springs may be used as high-strength elastic members.

Furthermore, in this embodiment, a case was mainly described in which the base end of the moving portion 3 is fixed to the wheeled platform 40, but there is no limitation to this. In this case, the transport apparatus 100 may transport the transport target object 5 within the operating range of the moving portion 3.

In the foregoing embodiment, each process or each function may be realized as centralized processing using a single apparatus or a single system, or may be realized as distributed processing using multiple apparatuses or multiple systems.

In the foregoing embodiment, each constituent element may be configured by dedicated hardware, or alternatively, constituent elements that can be realized by software may be realized by executing a program. For example, each constituent element may be realized by a program execution unit such as a CPU reading and executing a software program stored in a recording medium such as a hard disk or a semiconductor memory. At the time of executing the program, the program execution unit may execute the program while accessing the storage unit or the recording medium. Furthermore, this program may be executed by downloading from a server or the like, or may be executed by reading a program stored in a predetermined recording medium (e.g., an optical disk, a magnetic disk, a semiconductor memory, etc.). Furthermore, the program may be used as a program for constituting a program product. Furthermore, a computer that executes the program may be a single computer or may be multiple computers. That is to say, centralized processing may be performed, or distributed processing may be performed.

Furthermore, the foregoing embodiment is an example for specific implementation of the present invention and is not intended to limit the technical scope of the invention. The technical scope of the invention is indicated by the claims rather than by the foregoing description, and changes which come within the wording and equivalent meanings of the scope of the claims are intended to be encompassed therein.

What is claimed is:

1. A transport apparatus comprising:
first and second hand portions that are arranged at a distance from each other in a first direction in a horizontal plane and configured to simultaneously hold a transport target object, the first and second hand portions respectively including
first and second holding portions that hold the transport target object, and
first and second force sensors that respectively detect external forces applied to the first and second holding portions;
a moving portion that moves the first and second hand portions independently of each other in the first direction, as well as in a second direction that is perpendicular to the first direction in the horizontal plane and in a vertical direction; and
a control portion that controls the moving portion to move, toward a positioning point, the transport target object to which an upward force is applied within a range where the object does not float above a placement face, using the external forces detected by the first and second force sensors.

2. The transport apparatus according to claim 1, wherein the control portion changes the upward force that is applied to the transport target object within a range where the object does not float above the placement face, when moving the transport target object toward the positioning point.

3. The transport apparatus according to claim 1, wherein there is play between the first and second hand portions and the transport target object in a state in which the first and second hand portions hold the transport target object.

4. The transport apparatus according to claim 3, wherein faces of the first and second hand portions that come into contact with the transport target object when the first and second hand portions hold the transport target object are faces with a low coefficient of friction.

5. The transport apparatus according to claim 1, further comprising a wheeled platform to which a base end of the moving portion is fixed.
